(19) United States
(12) Patent Application Publication
(10) Pub. No.: US 2013/0140291 A1
(43) Pub. Date: Jun. 6, 2013

(54) Glass Substrate Slicing Apparatus and Method

(71) Applicants: Yi-Zhuang Zhuang, Shenzhen City (CN); Jung-Mao Tsai, Shenzhen City (CN); Shiue-Shih Liao, Shenzhen City (CN); Song-Xian Wen, Shenzhen City (CN); Ming--Feng Deng, Shenzhen City (CN)

(72) Inventors: Yi-Zhuang Zhuang, Shenzhen City (CN); Jung-Mao Tsai, Shenzhen City (CN); Shiue-Shih Liao, Shenzhen City (CN); Song-Xian Wen, Shenzhen City (CN); Ming--Feng Deng, Shenzhen City (CN)

(73) Assignee: Shenzhen China Star Optoelectronics Technology Co., LTD., Shenzhen City, Guangdong (CN)

(21) Appl. No.: 13/380,858

(22) PCT Filed: Dec. 14, 2011
(86) PCT No.: PCT/CN2011/084010

§ 371 Date: Dec. 26, 2011

(30) Foreign Application Priority Data
Dec. 5, 2011 (CN) 201110400362.6

(51) Int. Cl. H05B 7/18

(52) U.S. Cl. 219/383

(57) ABSTRACT

A glass substrate slicing apparatus is disclosed, which comprises a laser emitting device and a slicing device. The laser emitting device is adapted to emit a laser beam onto a surface of a glass substrate to be sliced so as to form micro-grooves on the surface of the glass substrate; and the slicing device is adapted to slice the glass substrate at locations of the micro-grooves, and comprises a wheel cutter fixing device and a diamond wheel cutter fixed on the wheel cutter fixing device. A laser beam is emitted by the laser emitting device to form micro-grooves on a surface of the glass substrate so that a diamond wheel cutter can be inserted into the micro-grooves to slice the glass substrate at locations of the micro-grooves. As a result, the frictional force between the diamond wheel cutter and the glass substrate can be enhanced to prevent slipping of the diamond wheel cutter during the slicing process, thus improving the slicing accuracy.

### FIELD OF THE INVENTION

The present disclosure generally relates to the technical field of liquid crystal display (LCD) panels, and more particularly, to a glass substrate slicing apparatus and method.

### BACKGROUND OF THE INVENTION

Currently, a thin film transistor liquid crystal display (TFT-LCD) panel is formed mainly by sandwiching a liquid crystal layer between an array substrate and a color film (CF) substrate through a cell process. The array substrate provides gate lines for scanning signals, signal lines for data signals and pixel electrodes. The manufacturing process of the LCD panel mainly comprises an array process for forming the array substrate and the CF substrate, a cell process for assembling the array substrate and the CF substrate together and filling a liquid crystal material therebetween, and a subsequent module process. The glass substrate comprises a plurality of LCD panels after the cell process, and the LCD panels are separated through a slicing and singulating process.

Referring to FIG. 1 and FIG. 2 together for the conventional slicing technology, FIG. 1 is a schematic structural view illustrating how a conventional glass substrate slicing apparatus slices a glass substrate, and FIG. 2 is a schematic structural view illustrating a crack produced by the conventional glass substrate slicing apparatus on a surface of the glass substrate. The glass substrate slicing apparatus 10 comprises a wheel cutter 101 and a fixing device 102 for fixing the wheel cutter 101. The wheel cutter 102 of the glass substrate slicing apparatus 10 slices the glass substrate along a slicing route, and a damaged region 103, a horizontal crack 104 and a vertical crack 105 are formed at a location where the wheel cutter 102 makes contact with the glass substrate. The vertical crack 105 is essential for the subsequent singulating process, but the horizontal crack 104 is unnecessary. Moreover, formation of the horizontal crack 104 causes excessive glass debris, and the glass debris will be attached to the surface of the glass substrate and the lines in a terminal region of the glass substrate to cause scratching or pollution to the surface of the glass substrate and the lines in subsequent processes, which will degrade the product quality. Meanwhile, the flying glass debris also causes pollution to the environment in the dust-free workshop. On the other hand, the wheel cutter suffers from a certain level of abrasion when slicing the glass substrate, and once the wheel cutter has sliced glass substrates for a certain length, the wheel cutter will fail and must be replaced with a new one.

### SUMMARY OF THE INVENTION

An objective of the present disclosure is to provide a glass substrate slicing apparatus and a glass substrate slicing method which can effectively improve the precision of slicing a glass substrate.

To achieve the aforesaid objective, the present disclosure provides a glass substrate slicing apparatus, which comprises: a first laser emitting device, being adapted to emit a laser beam onto a surface of a glass substrate to be sliced so as to form micro-grooves on the surface of the glass substrate; and a first slicing device, being adapted to slice the glass substrate at locations of the micro-grooves.

Preferably, the first laser emitting device and the first slicing device are disposed opposite to each other along a slicing movement direction.

Preferably, the glass substrate slicing apparatus further comprises a connecting device for connecting and holding the first laser emitting device and the first slicing device.

Preferably, the connecting device movably connects and holds the first laser emitting device and the first slicing device so that relative positions of the first laser emitting device and the first slicing device can be adjusted.

Preferably, the glass substrate slicing apparatus further comprises a cooling device for cooling the micro-grooves.

Preferably, the glass substrate slicing apparatus further comprises a second laser emitting device and a second slicing device, and a combination of the second laser emitting device and the second slicing device is disposed opposite to a combination of the first laser emitting device and the first slicing device so that the first slicing device and the second slicing device can slice two laminated glass substrates simultaneously.

Preferably, the first slicing device comprises a wheel cutter fixing device and a diamond wheel cutter fixed on the wheel cutter fixing device.

The present disclosure further provides a glass substrate slicing method, which comprises the following steps of: forming micro-grooves on a surface of a glass substrate at pre-sliced locations; slicing the glass substrate at locations of the micro-grooves; and singulating the glass substrate to form a plurality of liquid crystal display (LCD) panels.

Preferably, the step of forming micro-grooves is accomplished by a laser emitting device which emits a laser beam onto the surface of the glass substrate.

Preferably, the step of slicing the glass substrate at locations of the micro-grooves is to slice the glass substrate at the locations of the micro-grooves by use of a diamond wheel cutter.

Preferably, the diamond wheel cutter is inserted into the micro-grooves to slice the glass substrate.

Preferably, the glass substrate slicing method further comprises a step of cooling the micro-grooves.

Preferably, the steps of forming micro-grooves, slicing the glass substrate and singulating the glass substrate are carried out on two laminated glass substrates simultaneously.

According to the glass substrate slicing apparatus and the glass substrate slicing method of the present disclosure, a laser beam is emitted by the laser emitting device to form micro-grooves on a surface of the glass substrate so that a diamond wheel cutter slices the glass substrate at locations of the micro-grooves. As a result, the frictional force between the diamond wheel cutter and the glass substrate can be enhanced to prevent slipping of the diamond wheel cutter during the slicing process, to improve the slicing accuracy, and to reduce the horizontal cracks and the amount of glass debris generated during the slicing process. This can avoid scratching to the circuits on the glass substrate caused by the glass debris, improve the product quality and reduce the pollution caused by the glass debris to the dust-free workshop. Moreover, the abrasion between the diamond wheel cutter and the glass substrate can be reduced to prolong the service life of the diamond wheel cutter, thus reducing the production cost.

### BRIEF DESCRIPTION OF THE DRAWINGS

FIG. 1 is a schematic structural view illustrating how a conventional glass substrate slicing apparatus slices a glass substrate;

FIG. 2 is a schematic structural view illustrating a crack produced by the conventional glass substrate slicing apparatus on a surface of the glass substrate;

FIG. 3 is a schematic structural view illustrating how a first embodiment of a glass substrate slicing apparatus slices the glass substrate according to the present disclosure;

FIG. 4 is a schematic structural view illustrating how a laser emitting device of the first embodiment of the glass substrate slicing apparatus forms micro-grooves on a surface of the glass substrate according to the present disclosure;

FIG. 5 is a schematic structural view illustrating how a slicing device of the first embodiment of the glass substrate slicing apparatus produces a crack on the surface of the glass substrate according to the present disclosure;

FIG. 6 is a schematic structural view illustrating how a glass substrate slicing apparatus of a second embodiment slices the glass substrate according to the present disclosure; and

FIG. 7 is a flowchart diagram of a preferred embodiment of a glass substrate slicing method according to the present disclosure.

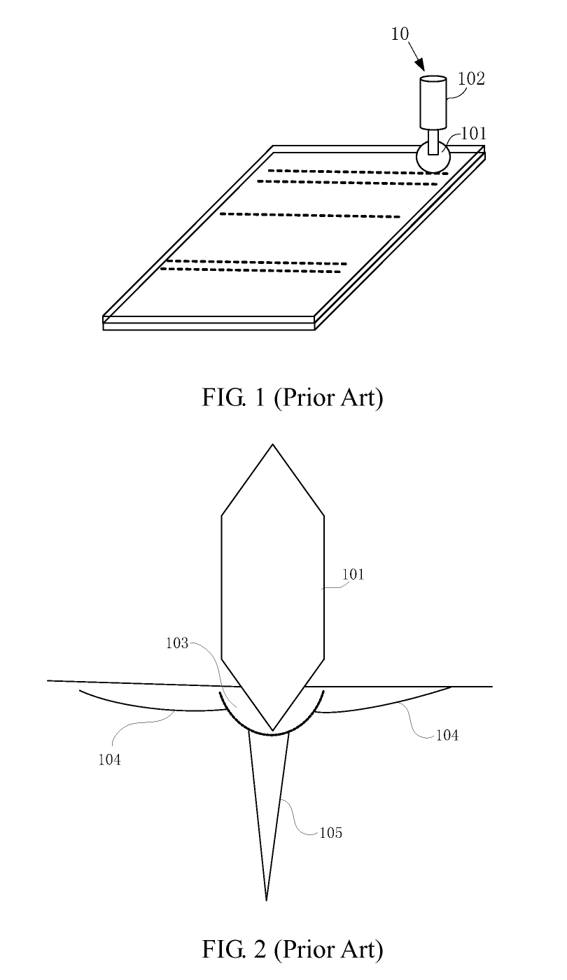

### DETAILED DESCRIPTION OF THE INVENTION

Various embodiments of the disclosure are now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

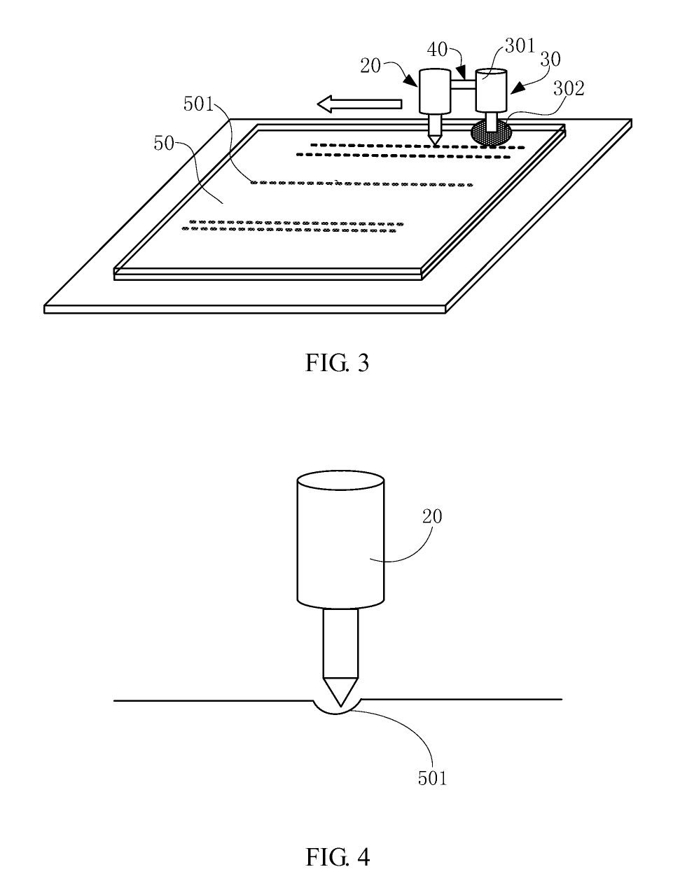

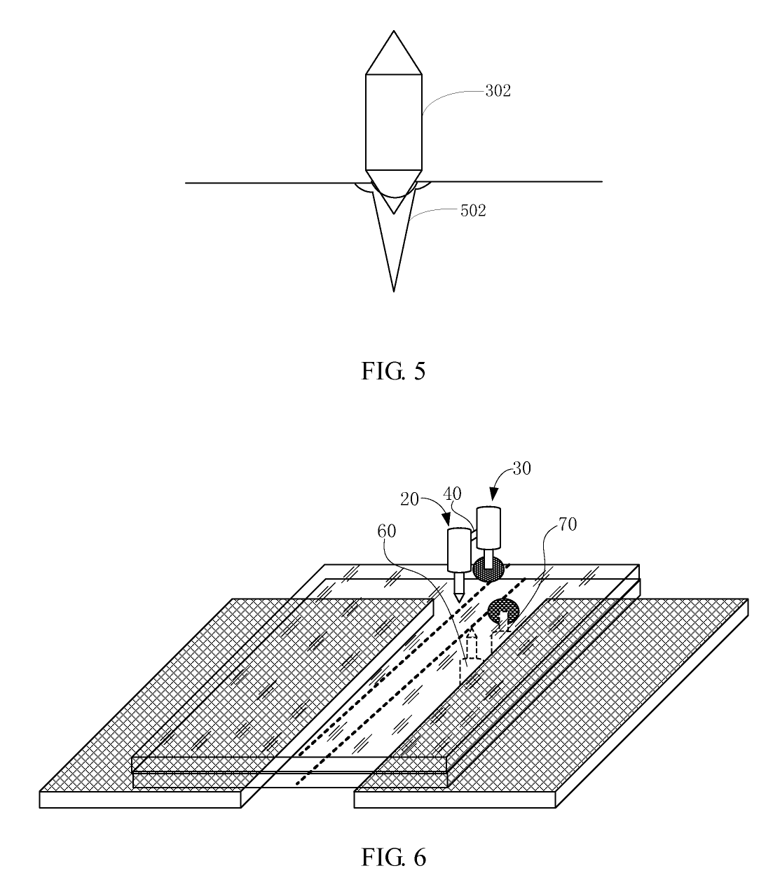

Referring to FIG. 3 to FIG. 5 together, a glass substrate slicing apparatus of a first embodiment of the present disclosure comprises a first laser emitting device 20, a first slicing device 30 and a connecting device 40. The first laser emitting device 20 and the first slicing device 30 are disposed opposite to each other along a slicing movement direction. The connecting device 40 connects and holds the first laser emitting device 20 and the first slicing device 30. Moreover, the connecting device 40 may be fixed between the first laser emitting device 20 and the first slicing device 30, or movably connect and hold the first laser emitting device 20 and the first slicing device 30 so that relative positions of the first laser emitting device 20 and the first slicing device 30 can be adjusted.

The first laser emitting device 20 may comprise a cooling device (not shown). The first laser emitting device 20 emits a laser beam onto pre-sliced locations on a surface of a glass substrate 50 to be sliced so as to form micro-grooves 501 on the surface of the glass substrate 50, and then the micro-grooves 501 is cooled by the cooling device. After the micro-grooves 501 cool down, this process proceeds to a next step.

The first slicing device 30 comprises a wheel cutter fixing device 301 and a diamond wheel cutter 302 fixed on the wheel cutter fixing device 301. During the slicing process, the diamond wheel cutter 302 slices the glass substrate at the locations of the micro-grooves 501, and the diamond wheel cutter 302 is inserted into the micro-grooves 501 to slice the glass substrate. Because the surface of the glass substrate 50 is formed with the micro-grooves 501, a vertical crack 502 is produced on the surface of the glass substrate 50 when the diamond wheel cutter 302 is inserted into the micro-grooves 501 to slice the glass substrate 50. Then, the glass substrate 50 is singulated according to the vertical crack 502 produced.

Referring further to FIG. 6, as another embodiment of the present disclosure, a glass substrate slicing apparatus of this embodiment further comprises a second laser emitting device 60 and a second slicing device 70 in addition to the components of the first embodiment. A combination of the second laser emitting device 60 and the second slicing device 70 is disposed opposite to a combination of the first laser emitting device 20 and the first slicing device 30 so that two laminated glass substrates can be sliced by the slicing devices simultaneously.

The second laser emitting device 60 and the second slicing device 70 is connected with each other by use of a second connecting device (not labeled), and are disposed opposite to each other along a slicing movement direction. The second connecting device connects and holds the second laser emitting device 60 and the second slicing device 70. Moreover, the second connecting device may be fixed between the second laser emitting device 60 and the second slicing device 70, or movably connect and hold the second laser emitting device 60 and the second slicing device 70 so that relative positions of the second laser emitting device 60 and the second slicing device 70 can be adjusted.

Like the first slicing device 30, the second slicing device 70 also comprises a wheel cutter fixing device and a diamond wheel cutter fixed on the wheel cutter fixing device. Furthermore, the second laser emitting device 60 may comprise a second cooling device (not shown) for cooling micro-grooves formed on the surface of the glass substrate to be sliced by the second laser emitting device 60.

During the slicing process, two laminated glass substrates (not labeled) are provided at the same time between the combination of the first laser emitting device 20 and the first slicing device 30 and the combination of the second laser emitting device 60 and the second slicing device 70. The first laser emitting device 20 and the second laser emitting device 60 disposed opposite to each other in the vertical direction emit laser beams onto opposite surfaces of the two laminated glass substrates respectively so as to form micro-grooves along a predetermined slicing direction. Then, the diamond wheel cutters of the first slicing device 30 and the second slicing device 70 disposed opposite to each other in the vertical direction slice the two laminated glass substrates at locations of the micro-grooves on the opposite surfaces, and the diamond wheel cutters may be inserted into the micro-grooves to slice the glass substrates to form vertical cracks. Finally, the glass substrate is singulated.

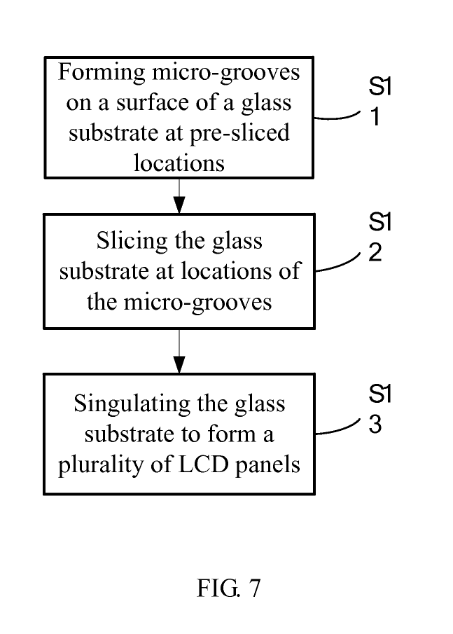

Referring next to FIG. 7, a flowchart diagram of a preferred embodiment of a glass substrate slicing method according to the present disclosure is shown therein. The preferred embodiment comprises the following steps.

Step S11: forming micro-grooves on a surface of a glass substrate at pre-sliced locations;

Step S12: slicing the glass substrate at locations of the micro-grooves; and

Step S13: singulating the glass substrate to form a plurality of liquid crystal display (LCD) panels.

The step of forming micro-grooves is accomplished by a laser emitting apparatus which emits a laser beam onto the surface of the glass substrate, and the micro-grooves are cooled after being formed. The step of slicing the glass substrate at locations of the micro-grooves is to slice the glass substrate at the locations of the micro-grooves by use of a diamond wheel cutter, and moreover, the diamond wheel cutter is inserted into the micro-grooves to slice the glass substrate.

As a further embodiment of the present disclosure, the steps of forming micro-grooves, slicing the glass substrate and singulating the glass substrate are carried out on two laminated glass substrates simultaneously.

According to the glass substrate slicing apparatus and the glass substrate slicing method of the present disclosure, a laser beam is emitted by a laser emitting device to form micro-grooves on a surface of a glass substrate in advance so that a diamond wheel cutter can be inserted into the micro-grooves to slice the glass substrate at locations of the micro-grooves. As a result, the frictional force between the diamond wheel cutter and the glass substrate can be enhanced to prevent slipping of the diamond wheel cutter during the slicing process, to improve the slicing accuracy, and to reduce the horizontal cracks and the amount of glass debris generated during the slicing process. This can avoid scratching to the circuits on the glass substrate caused by the glass debris, improve the product quality and reduce the pollution caused by the glass debris to the dust-free workshop. Moreover, the abrasion between the diamond wheel cutter and the glass substrate can be reduced to prolong the service life of the diamond wheel cutter, thus reducing the production cost.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A glass substrate slicing apparatus, comprising:
a first laser emitting device, being adapted to emit a laser beam onto a surface of a glass substrate to be sliced so as to form micro-grooves on the surface of the glass substrate; and
a first slicing device, being adapted to slice the glass substrate at locations of the micro-grooves.

2. The glass substrate slicing apparatus of claim 1, wherein the first laser emitting device and the first slicing device are disposed opposite to each other along a slicing movement direction.

3. The glass substrate slicing apparatus of claim 2, further comprising a connecting device for connecting and holding the first laser emitting device and the first slicing device.

4. The glass substrate slicing apparatus of claim 3, wherein the connecting device movably connects and holds the first laser emitting device and the first slicing device so that relative positions of the first laser emitting device and the first slicing device can be adjusted.

5. The glass substrate slicing apparatus of claim 1, further comprising a cooling device for cooling the micro-grooves.

6. The glass substrate slicing apparatus of claim 1, further comprising a second laser emitting device and a second slicing device, and a combination of the second laser emitting device and the second slicing device is disposed opposite to a combination of the first laser emitting device and the first slicing device so that the first slicing device and the second slicing device can slice two laminated glass substrates simultaneously.

7. The glass substrate slicing apparatus of claim 1, wherein the first slicing device comprises a wheel cutter fixing device and a diamond wheel cutter fixed on the wheel cutter fixing device.

8. A glass substrate slicing method, comprising the following steps of:
forming micro-grooves on a surface of a glass substrate at pre-sliced locations;
slicing the glass substrate at locations of the micro-grooves; and
singulating the glass substrate to form a plurality of liquid crystal display (LCD) panels.

9. The glass substrate slicing method of claim 8, wherein the step of forming micro-grooves is accomplished by a laser emitting device which emits a laser beam onto the surface of the glass substrate.

10. The glass substrate slicing method of claim 8, wherein the step of slicing the glass substrate at locations of the micro-grooves is to slice the glass substrate at the locations of the micro-grooves by use of a diamond wheel cutter.

11. The glass substrate slicing method of claim 10, wherein the diamond wheel cutter is inserted into the micro-grooves to slice the glass substrate.

12. The glass substrate slicing method of claim 8, further comprising a step of cooling the micro-grooves.

13. The glass substrate slicing method of claim 8, wherein the steps of forming micro-grooves, slicing the glass substrate and singulating the glass substrate are carried out on two laminated glass substrates simultaneously.
